(19) United States
(12) Patent Application Publication
(10) Pub. No.: US 2008/0165692 A1
(43) Pub. Date: Jul. 10, 2008

(54) METHOD AND SYSTEM FOR OPPORTUNISTIC DATA COMMUNICATION

(75) Inventors: Guenael T. Strutt, Sanford, FL (US); Shyamal Ramachandran, Heathrow, FL (US); Sebnem Zorlu Ozer, North Wales, PA (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/619,827

(22) Filed: Jan. 4, 2007

(51) Int. Cl. G08C 15/00

(52) U.S. Cl. 370/236

(57) ABSTRACT

A method is provided for communicating data items across one or more disjoined networks. The method comprises receiving a message including a data item information list having data item information associated with each of one or more data items stored in a node of the disjoined networks; ranking each of the data items based on each of the associated data item information; comparing each of the associated data item information of the ranked data items with a local data index information list to select one or more data items requiring updating; and sending a request for updating the selected data items.

### FIELD OF THE INVENTION

The present invention relates generally to wireless communications networks, and more particularly to a method and system for opportunistic data communication within one or more fault tolerant communication networks.

### BACKGROUND

Wireless communications networks, such as mobile wireless telephone networks, have become increasingly prevalent over the past decade. Wireless communication networks can include infrastructure-based wireless networks, ad hoc networks, or a combination thereof.

An infrastructure-based wireless network typically includes a communication network with fixed and wired gateways. Many infrastructure-based wireless networks employ a mobile unit or host which communicates with a fixed base station that is coupled to a wired network. The mobile unit can move geographically while it is communicating over a wireless link to the base station. When the mobile unit moves out of range of one base station, it may connect or “handover” to a new base station and starts communicating with the wired network through the new base station.

In recent years, a type of mobile communications network known as an “ad-hoc multi-hopping” network has been developed. In this type of network, each mobile node is capable of operating as a router for the other mobile nodes providing most of the functionality of a base station, thus expanding the coverage area with very little cost.

More sophisticated ad-hoc networks are also being developed which, in addition to enabling mobile nodes to communicate with each other as in a conventional ad-hoc network, further enable the mobile nodes to access a fixed network and thus communicate with other fixed or mobile nodes, such as those on the public switched telephone network (PSTN), and on other networks such as the Internet.

Communication with fixed communications networks can be established by extending the wired networks to wireless networks. Some ad-hoc networks, such as mesh networks, have been used, for example, to provide range extension by providing nodes in the mesh networks to act as repeaters to transmit data from nearby nodes to peers that are too far away to reach, resulting in a network that can span large distances, especially over rough or difficult terrain.

Extension of a network presumes that nodes in the network being used for the extension are interconnected at all times; and that it is possible to send data traffic through the network in an amount of time that is acceptable to the network protocol used. However, such extension of networks may lead to the formation of one or more disjoined networks caused by hardware failures and/or mobility of the nodes participating in the wireless networks. It will be appreciated that such disjoined networks can make it difficult to send the traffic in an acceptable amount of time. Further, limited bandwidth availability can exacerbate the problems associated with disjoined networks.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an exemplary ad-hoc wireless communications network including a plurality of nodes employing a system and method in accordance with at least some embodiments of the present invention;

FIG. 2 is a block diagram illustrating an exemplary mobile node employed in the network shown in FIG. 1;

FIG. 3 is a block diagram of a media database associated with the exemplary mobile node of FIG. 2 in accordance with at least some embodiments of the present invention;

FIG. 4 is an exemplary message frame format diagram of a media catalogue message (MREQ);

FIG. 5 is an exemplary message frame format diagram of a media request message (MCAT);

FIG. 6 is an exemplary message frame format diagram of a media push message (MPUSH);

FIG. 7 is an exemplary message frame format diagram of a media push reply message (MPUSH_REPLY);

FIG. 8 is an exemplary message frame format diagram of a media pull message (MPULL);

FIG. 9 is an exemplary message frame format diagram of a media pull reply message (MPULL_REPLY);

FIG. 10 is an exemplary message frame format diagram of a media file transfer message (MFT);

FIG. 11 is a flowchart illustrating a PULL procedure, according to an exemplary embodiment of the present invention;

FIG. 12 is a flowchart illustrating a PULL procedure, according to an exemplary embodiment of the present invention;

FIG. 13 is an exemplary message flow diagram illustrating a single-hop PULL procedure, according to an exemplary embodiment of the present invention;

FIG. 14 is an exemplary message flow diagram illustrating a multi-hop PULL procedure, according to an exemplary embodiment of the present invention;

FIG. 15 is a flowchart illustrating a PUSH procedure, according to an exemplary embodiment of the present invention;

FIG. 16 is a flowchart illustrating a PUSH procedure, according to an exemplary embodiment of the present invention;

FIG. 17 is an exemplary message flow diagram illustrating a single-hop PUSH procedure, according to an exemplary embodiment of the present invention;

FIG. 18 is an exemplary message flow diagram illustrating a multi-hop PUSH procedure, according to an exemplary embodiment of the present invention;

FIGS. 19A, 19B, and 19C illustrate an exemplary broadcast alert scenario in a disjoined Intelligent Transportation System (ITS) network, according to an embodiment of the present invention; and

FIGS. 20A, 20B, and 20C illustrate an exemplary software update scenario in a public access network, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to opportunistic data communication within one or more fault tolerant networks. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of opportunistic data communication within one or more fault tolerant networks described herein. The non-processor circuits may include, but are not limited to, a radio receiver, a radio transmitter, signal drivers, clock circuits, power source circuits, and user input devices. As such, these functions may be interpreted as steps of a method to perform the communication of data within one or more fault tolerant networks. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

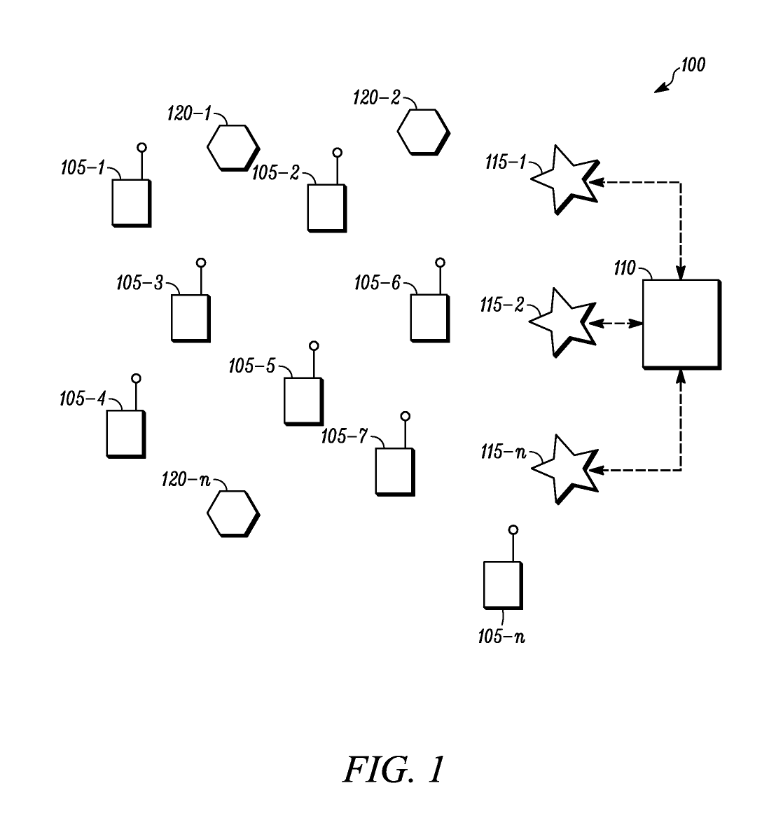

FIG. 1 is a block diagram illustrating an exemplary ad-hoc wireless communications network 100 employing at least some embodiments of the present invention. Specifically, the network 100 includes a plurality of mobile wireless user terminals 105-1 through 105-n (referred to generally as nodes 105 or mobile nodes 105), and can, but is not required to, include a fixed network 110 having a plurality of access points 115-1 through 115-n (referred to generally as nodes 115, access points (APs) 115 or intelligent access points (IAPs) 115), for providing nodes 105 with access to the fixed network 110. The fixed network 110 can include, for example, a core local area network (LAN), and a plurality of servers and gateway routers to provide network nodes with access to other networks, such as other ad-hoc networks, the public switched telephone network (PSTN) and the Internet. The network 100 further can include a plurality of fixed routers 120-1 through 120-n (referred to generally as nodes 120, wireless routers (WRs) 120 or fixed routers 120) for routing data packets between other nodes 105, 115 or 120. It is noted that for purposes of this discussion, the nodes discussed above can be collectively referred to as “nodes 105, 115 and 120”, or simply “nodes”.

As can be appreciated by one skilled in the art, the nodes 105, 115 and 120 are capable of communicating with each other directly, or via one or more other nodes 105, 115 or 120 operating as a router or routers for packets being sent between nodes.

The nodes 105, 115 or 120 may be highly mobile nodes that are interconnected to form a transit network to connect other nodes 105, 115 or 120 forming one or more disjoined ad-hoc wireless communication networks 100. Such disjoined wireless networks comprising of at least some highly mobile nodes 105, 115 or 120 may be grouped into a class of networks referred to as delay-tolerant networks (DTN) or fault-tolerant networks. The connectivity of such a DTN is defined in time (i.e. the network may be disconnected at one point in time, but connected over a period of time), and traffic forwarding in the DTN is opportunistic, which means that even if end-to-end connectivity is not achieved, time-insensitive connectivity can take place.

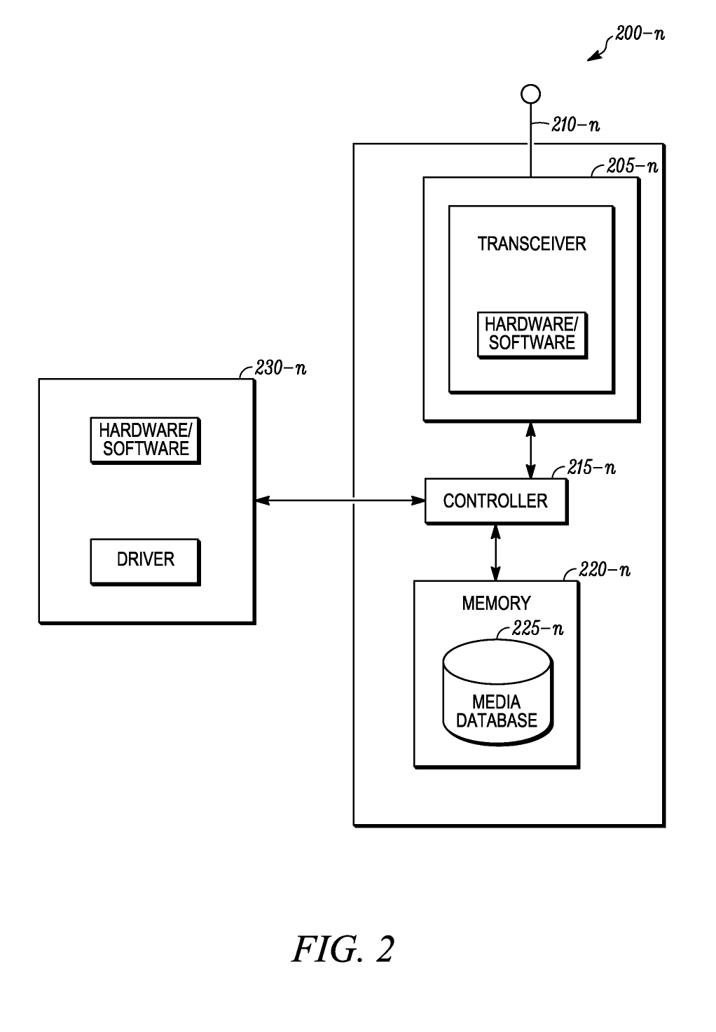

FIG. 2 is a block diagram of an exemplary node 200-n (referred to generally as node 200) which can be employed in the network 100. The node 200-n, for example, may be selected from the group comprising mobile nodes 105-n, access points 115-n, routers 120-n, or any combination thereof. The node 200-n includes at least one transceiver or modem 205-n, which is coupled to an antenna 210-n for receiving and transmitting signals, such as packetized signals, to and from the node 200-n, under the control of a controller 215-n. The packetized data signals can include, for example, voice, data or multimedia information, and packetized control signals, including node update information.

The node 200-n further includes a memory 220-n, such as a random access memory (RAM) for storing, among other things, routing information pertaining to itself and other nodes 200 in the network 100. The memory 220-n comprises a media database 225-n.

As further shown in FIG. 2, particularly when the node 200-n is a mobile node, the node 200-n can include a host 230-n which may consist of any number of devices, such as a notebook computer terminal, mobile telephone unit, mobile data unit, or any other suitable device. The node 200-n also can include the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included.

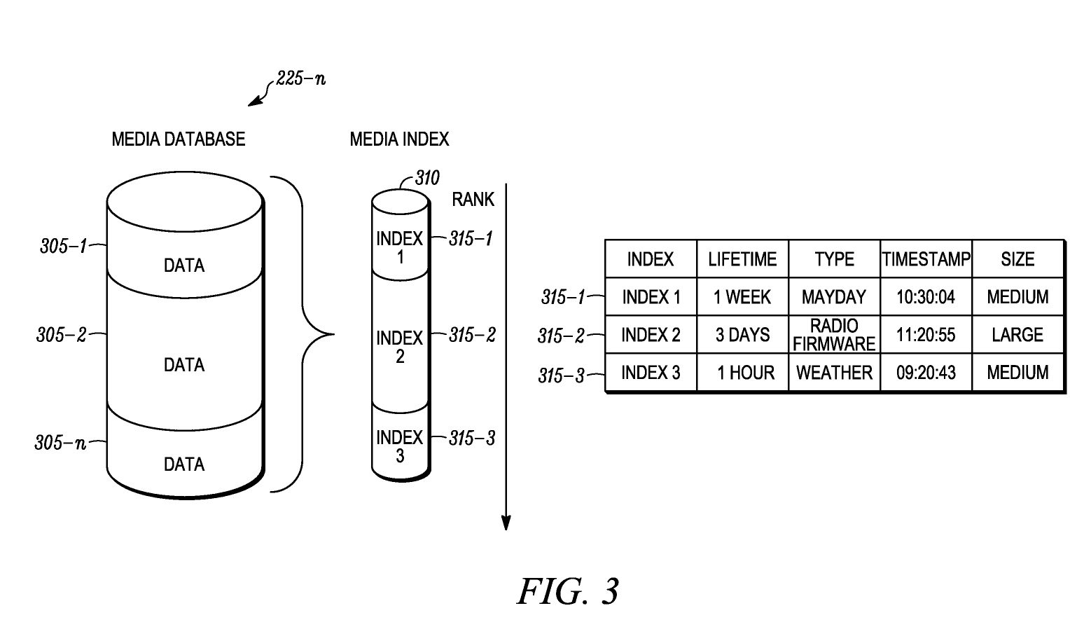

FIG. 3 is a block diagram of the media database 225-n associated with the node 200-n employed in the network 100. The media database 225-n can, for example, take the form of a distributed database that is capable of storing data items 305-n (also referred to as media items 305-n). The media database 225-n further comprises an index list 310 (also referred to as data item information list 310) for storing data item information 315-n related to the data items 305-n. In one embodiment, the index list 310 includes information such as priority, lifetime, type, timestamp, size, and the like. The information stored in the index list 310 can be used to compute a rank for each of the data items 305-n. In one embodiment, the rank of the data items 305-n is determined using the equation:

$$Rank = \frac{Lifetime - ( Time - Timestamp )}{Lifetime} \cdot [ ( Time - Timestamp ) > Lifetime ] \cdot priority \cdot \frac{1}{Size}$$

As can be appreciated by one skilled in the art, the purpose of the ranking equation is to diminish the rank of a media item 305 if: (1) time has elapsed since the data item 305 has been created; (2) the priority is low and (3) the size is large. Also, the ranking equation allows a data item 305 to be assigned a rank of zero if the time elapsed since the data item 305 has been created is larger than the lifetime. The ranking equation uses simple linear relationships between inputs (Time, Priority etc.) and output (the Rank). Depending on the application, the relationship may be derived from a logarithm, a polynomial, or any other mathematical procedure that is deemed suitable.

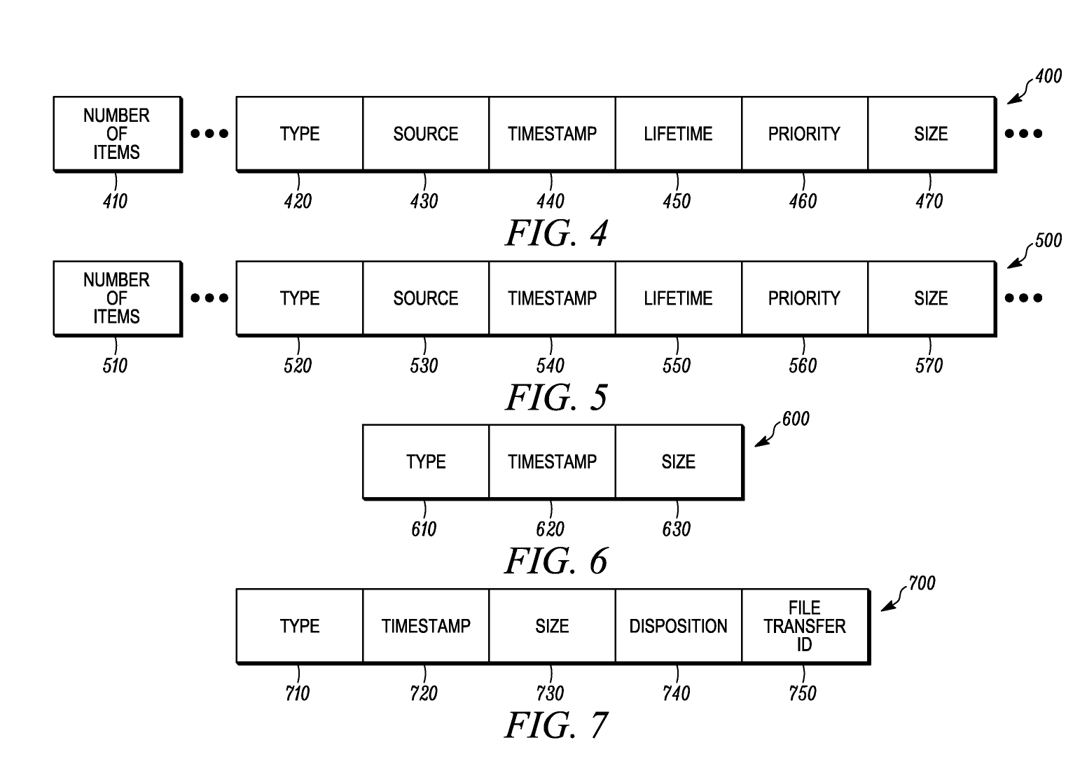

The node 200-n uses the data item information 315-n stored in the index list 310 of a file system to generate different messages that are used for the purposes of transmitting the data items 305-n contained in the media database 225-n at predetermined intervals and requesting the data items 305 stored in the media database 225 of other nodes 200 when needed. FIGS. 4-10 illustrate the different messages used for communicating the data items 305 across the network 100, in accordance with at least some embodiments of the present invention.

Referring to FIG. 4, a message format of a media catalogue (MCAT) message 400 is illustrated. The MCAT message 400 includes data item information list 310 having data item information 315 contained in the media database 225-1 of a first node 200-1. When the first node 200-1 wants to transmit the data items 305-n to one or more other nodes 200-2 through 200-n in the network 100, it broadcasts the MCAT message 400 including data item information list 310 related to those data items 305-n. It will be appreciated that the process of transmitting data item information 315 from the index list 310 associated with the data items 305-n, rather than the data items 305-n itself, reduces required communication bandwidth. Each of the other nodes 200-2 through 200-n receiving the MCAT message 400 analyzes the data item information 315 contained in the MCAT message 400 and selects items that are required. The MCAT message 400 includes one or more fields, each of the fields including specific information related to the data items 305-n. The ‘number of items’ field 410 identifies a value equal to the number of data items 305 which information is included in MCAT message 400. For example, if the number of items is 4, then the MCAT message 400 includes data item information 315 related to four items. The ‘type’ field 420 identifies the type of information stored in the data items 305-n. For example, the ‘type’ of the data item 305 may be weather information, emergency information, personal messages, news, and the like. The ‘Source’ field 430 is a field identifying the entity that generated the content of the media item. The ‘Source’ may be a MAC address, a domain name, a Uniform Resource Name (URN), a subscription identifier, a Usenet newsgroup, or any mechanism that uniquely identifies a content generator or a content repository. As can be appreciated by one skilled in the art, the ‘Type’ field 420, and ‘Source’ field 430 are used to uniquely identify the content of the data item 305-n of a media database 225-n. A network may combine both fields into one ‘Source identifier’ or split ‘Type’ and ‘Source’ into a set of hierarchical identifiers (e.g. Usenet or SNMP). The ‘timestamp’ field 440 identifies the time at which the data item 305-n originated. The ‘lifetime’ field 450 identifies a time period, after which the data item 305-n will become obsolete. For example, the data item 305-n containing weather information of a particular day may have a ‘lifetime’ of one day. In other words, the weather information of a particular day will become obsolete the next day. The ‘priority’ field 460 identifies the importance of the data item 305-n. For example, the data item 305-n may be assigned a priority of either ‘high’ or ‘low’. The ‘size’ field 470 of the data item 305-n identifies how much memory space the data item 305-n occupies. The ‘size’ of the data item 305-n may be represented in terms of “large”, “medium”, and “small”, or it may be represented by the actual memory space the data item 305-n occupies in the media database 225-1.

Now referring to FIG. 5, a message format of a media request (MREQ) message 500 is illustrated. A first node 200-1 broadcasts a MREQ message 500 to one or more other nodes 200-2 through 200-n in the network 100, whenever the first node 200-1 needs one or more data items 305. The MREQ message 500 includes data item information list 310 having data item information 315 associated with the one or more data items 305 required by the first node 200-1. Each of the other nodes 200-2 through 200-n receiving the MREQ message 500 analyzes the data item information 315 contained in the MREQ message 500 to decide if it currently has requested data items 305 in its media database 225-2 through 225-n. The MREQ message 500 includes one or more fields, each of the fields including specific information from the index list 310 related to the data items 305 that are needed. The ‘number of items’ field 510 identifies a value equal to the number of data items 305 which are included in MREQ message 500 (i.e. the number of data items 305 required by the first node 200-1 transmitting the MREQ message 500). The ‘type’ field 520 identifies the type of information stored in the data. For example, the type of the data item 305 may be weather information, emergency information, personal messages, news, and the like. The ‘Source’ field 530 is a field identifying the entity that generated the content of the media item 305. The ‘Source’ may be a MAC address, a domain name, a subscription identifier, a Usenet list, or any mechanism that uniquely identifies a content generator or a content repository. The “timestamp” field 540 is an optional field that identifies the time at which the data item 305 originated. The “lifetime” field 450 identifies a time period during which the data item 305 is relevant. For example, the data item 305 containing weather information of a particular day will have a lifetime of one day. In other words, the weather information will be relevant only for that particular day. The ‘priority’ field 560 is an optional field that identifies the importance of the data item 305. For example, the data item 305 may be assigned a priority of either ‘high’ or ‘low’. The ‘size’ field 570 of MREQ message 500 is an optional field which identifies how much memory space the data item 305 occupies. The size of the data item 305 may be represented in terms of “large”, “medium”, and “small”, or it may be represented by the actual memory space the data item 305 occupies in the media database 225.

Referring to FIG. 6, a message format of a media push (MPUSH) message 600 is illustrated. Whenever a first node 200-1 receives a MREQ message from a second node 200-2, and the first node 200-1 determines that it is capable of transmitting some of the data items 305-n that the second node 200-2 is requesting, the first node 200-1 replies with a MPUSH message 600 including information related to the data item 305-n that the first node 200-1 is capable of transmitting to the second node 200-2. The ‘Type’ field 610 of a MPUSH message 600 identifies the type of information stored in the data item 305-1. For example, the type of the data item 305-1 may be weather information, emergency information, personal messages, news, and the like. The ‘timestamp’ field 620 identifies the time at which the data item 305-1 originated. The ‘size’ field 630 identifies how much memory space the data item 305-1 occupies. The size of the data item 305-1 may be represented in terms of “large”, “medium”, and “small”, or it may be represented by the actual memory space the data item 305-1 occupies in the media database 225-1.

FIG. 7 illustrates a message format of a media push reply (MPUSH_REPLY) message 700. When a first node 200-1 receives a MPUSH message from a second node 200-2, the first node 200-1 determines if it is capable of receiving the data item 305-2 and sends a MPUSH_REPLY message 700 to the second node 200-2 with either an acknowledgment or negative acknowledgment. The ‘type’ field 710 of the MPUSH_REPLY message 700 identifies the type of information stored in the data item 305-2. For example, the type of the data item 305-2 may be weather information, emergency information, personal messages, news, and the like. The ‘timestamp’ field 720 identifies the time at which the data item 305-2 originated. The ‘size’ field 730 identifies how much memory space the data item 305-2 occupies. The size of the data item 305-2 may be represented in terms of “large”, “medium”, and “small”, or it may be represented by the actual memory space, the data item 305-2 occupies in the media database 225-2. The ‘disposition’ field 740 is a one bit field corresponding to acknowledgement (ACK) or negative acknowledgement (NACK). The ACK indicates that the first node 200-1 has decided to accept the data item 305-2 in response to MPUSH message 600. The NACK indicates that the first node 200-1 has decided not to accept the data item in response to the MPUSH message 600. The ‘File Transfer ID’ field 750 identifies a unique number corresponding to the transfer of a particular data item 305-2. If the ‘disposition field’ 740 contains a NACK, then the ‘File Transfer ID 750 may have a null value.

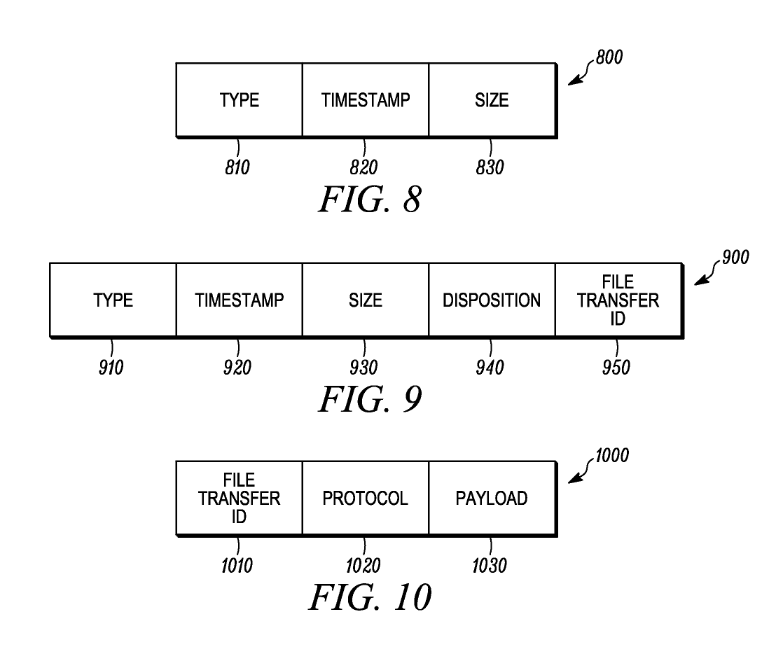

Referring to FIG. 8, a message format of a media pull message (MPULL) 800 is illustrated. In response to receiving a MCAT message 400 from a second node 200-2, a first node 200-1 selects a data item 305-2 and requests the transfer of selected items by sending a MPULL message 800. The MPULL message 800 includes information related to the selected data item 305-2. The ‘type’ field 810 identifies the type of information stored in the data item 305-2. For example, the type of the data item 305-2 may be weather information, emergency information, personal messages, news, and the like. The ‘timestamp’ field 820 identifies the time at which the data item 305-2 originated. The ‘size’ field 830 identifies how much memory space the data item 305-2 occupies. The size of the data item 305-2 may be represented in terms of “large”, “medium”, and “small”, or it may be represented by the actual memory space the data item 305-2 occupies in the media database 225-2.

FIG. 9 illustrates a message format of a media pull reply (MPULL_REPLY) message 900. A first node 200-1, after receiving a MPULL message 800 from a second node 200-2, determines if it is capable of transmitting the selected data item 305-1, and sends a MPULL_REPLY message 900 with an ACK or a NACK. The ‘Type’ field 910 identifies the type of information stored in the data item 305-1. For example, the type of the data item 305-1 may be weather information, emergency information, personal messages, news, and the like. The ‘timestamp’ field 920 identifies the time at which the data item 305-1 originated. The ‘size’ field 930 identifies how much memory space the data item 305-1 occupies. The size of the data item 305-1 may be represented in terms of “large”, “medium”, and “small”, or it may be represented by the actual memory space, the data item 305-1 occupies in the media database 225-1. The ‘disposition’ field 940 is a one bit field corresponding to an ACK or a NACK. The ACK identifies that the first node 200-1 has decided to transmit the data item 305-1 in response to a MPULL message 800. The NACK identifies that the first node 200-1 has decided not to transmit the data item 305-1 in response to the MPULL message 800 (for example, it may no longer have the data item 305-1, or it may have too many file transfer requests pending, or the channel may be too congested). The ‘File Transfer ID’ field 950 identifies a unique number corresponding to the transfer of the data item 305-1. If the ‘disposition field’ 740 contains a NACK, then the ‘File Transfer ID’ 750 may have a null value.

Referring to FIG. 10, a media file transfer (MFT) message format is illustrated. The MFT message 1000 contains information related to the file transfer of the data item 305-1. Whenever a first node 200-1 receives a MPUSH_REPLY with an ACK from a second node 200-2, then the first node 200-1 initiates a file transfer of the data item 305-1 by transmitting a MFT message to the second node 200-2. In other embodiments, the first node 200-1 initiates a file transfer of the data item 305-1 after transmitting the MPULL_REPLY with an ACK. The ‘File Transfer ID’ field 1010 of the MFT message 1000 represents a unique number corresponding to the transfer of the data item 305-1. The ‘protocol’ field 1020 identifies the protocol used in the transfer of the data item 305-1. For example, if the ‘protocol’ field 1020 has a value of ‘01’, then it may represent Trivial File Transfer Protocol (TFTP), or if the ‘protocol’ field 1020 has a value of ‘02’, it may represent Secure File Transfer Protocol (SFTP). The ‘payload’ field 1030 contains encapsulated data item 305-1, or chunks of data item 305-1 that is being transferred to the second node 200-2, as well as information that is specific to the protocol 1020 used.

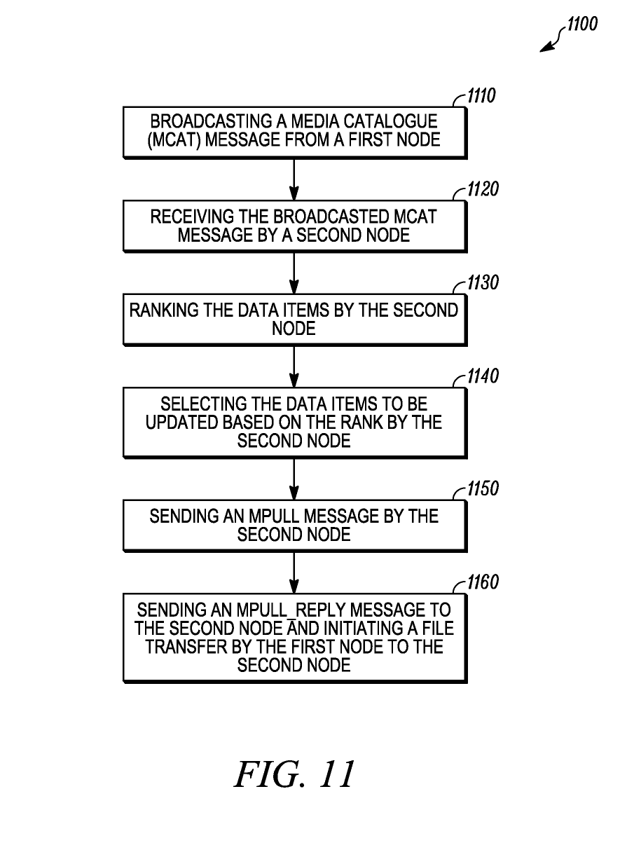

FIG. 11 is a flowchart of a PULL procedure 1100 in accordance with at least some embodiments of the present invention. At Step 1110, a first node 200-1 broadcasts at predetermined intervals an MCAT message 400 including data item information list 310 having data item information 315-n associated with one or more of the data items 305-n contained in the media database 225-1 of the first node 200-1. Next, at Step 1120, the broadcasted MCAT message 400 is received by at least one other nodes 200-2 through 200-n. For example, a second node 200-2 in the network 100 receives the MCAT message 400. Next, in Step 1130, the second node 200-2 receiving the broadcasted MCAT message 400 ranks the data item 305-1 based on the data item information 315-1 stored in the MCAT message 400. Next, in Step 1140, the second node 200-2 compares each of the associated data item information 315 of the ranked data items with a local data index information list 310, and selects the data items 305-1 that need to be updated in the media database 225-2 of the second node 200-2 based on the rank associated with each of the data items 305-1 of the MCAT message 400. In one embodiment, the step of comparing the data item information 315 of the ranked data items comprises comparing the rank of the data item 305-1 to be updated from the MCAT message 400 with the rank of the data item information 315 in the local data index information list 310. Next, in Step 1150, the second node 200-2 sends a MPULL message 800 to the first node 200-1, the MPULL message 800 including data item information 315 from the index list 310 related to the selected items. Next, in Step 1160, the first node 200-1, after receiving the MPULL message 800, sends a MPULL_REPLY message 900 to the second node 200-2, and subsequently initiates a file transfer of the selected items via an MFT message 1000 if the first node 200-1 receives the MPULL_REPLY message 900 with an ACK from the second node 200-2.

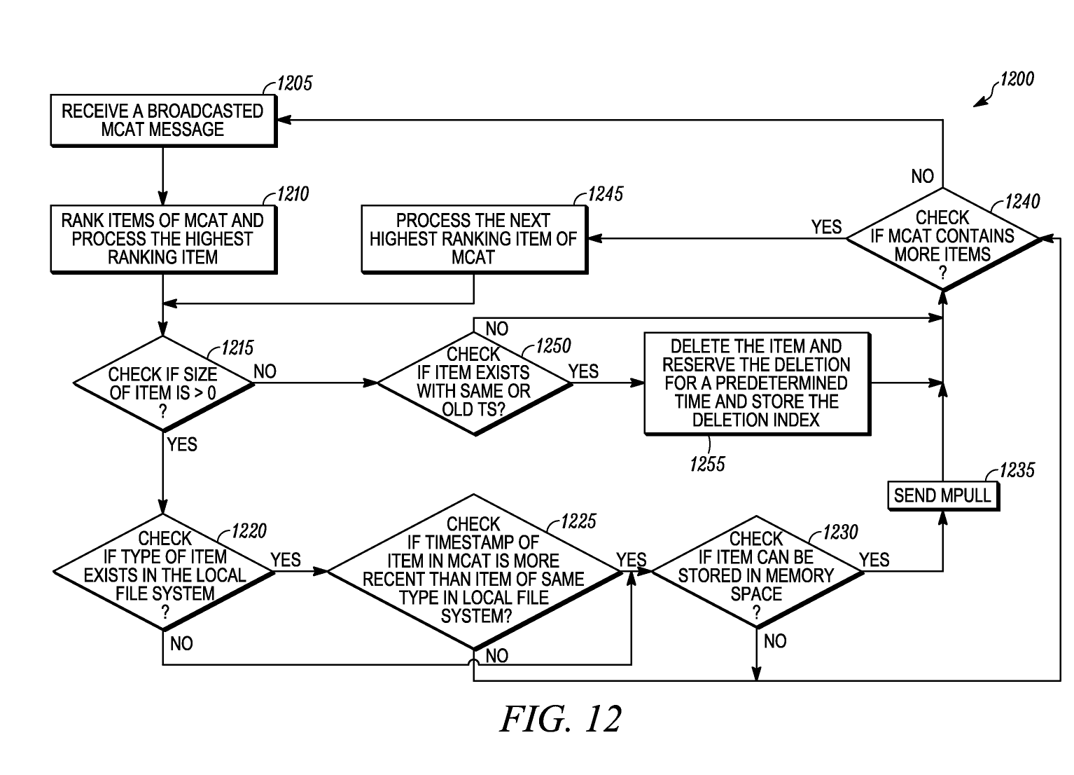

FIG. 12 is a flowchart of a PULL procedure 1200, according to at least some embodiments of the present invention. In Step 1205, a first node 200-1 receives, at predetermined intervals, a broadcasted MCAT message 400 including data item information list 310 having data item information 315-n associated with one or more data items 305-n contained in the media database 225-2 to 225-n of one of the other nodes 200-2 through 200-n. For example, the first node 200-1 receives data item information 315-n relevant to one or more data items 305-n contained in the media database 225-2 of a second node 200-2 in the network 100. Next, in Step 1210, after receiving the broadcasted MCAT message 400, the first node 200-1 ranks items from the index list 310 of the MCAT message 400 based on the information contained in the MCAT message 400. The rank of the items of the index list 310 may be calculated, for example, based on information such as priority, lifetime, and size of the data items 305-n contained in the MCAT message 400. The first node 200-1 compares the rank of the data item 305-n in the data item information list 310 with the rank of the data item information 315 in the local data index information list 310, and further reorders the ranked items in a decreasing order, and begins to process the highest ranked item. Next, in Step 1215, the first node 200-1 checks whether the ‘size’ of the highest ranked item is greater than zero. When it is determined that the size of the highest ranked item is greater than zero, the operation continues to Step 1220, in which the first node 200-1 checks whether the ‘type’ of the item already exists in its local media database 225-1. When the ‘type’ of the item already exists in the local media database 225-1 of the first node 200-1, the operation continues to Step 1225, in which the first node 200-1 determines if the ‘timestamp’ of the item 305-1 of MCAT message 400 is more recent than the ‘timestamp’ of the corresponding item from the index list 310 existing in the local media database 225-1 of the first node 200-1. When the ‘timestamp’ of the item 305-1 of MCAT message 400 is more recent than the item of the index list 310 existing in the local media database 225-1 of the first node 200-1 in Step 1225, or when the ‘type’ of the item 305-1 does not exist in the local media database 225-1 of the first node 200-1 in Step 1220, then at Step 1230, the first node 200-1 checks the ‘size’ of the item 305-1 and further checks whether the item 305-1 of MCAT message 400 can be stored in the memory space of the media database 225-1 of the first node 200-1 (i.e. the first node 200-1 checks whether the media database 225-1 has enough memory space to store the data item 305-1). When the first node 200-1 determines that the media database 225-1 has enough space to store the data item 305-1, the operation continues to Step 1235 wherein the first node 200-1 sends a MPULL message 800 to the second node 200-2 that had previously broadcasted the MCAT message 400. The transmission of MPULL message 800 indicates that the first node 200-1 has decided to accept the data item 305-1 from the second node 200-2 that had previously broadcasted the MCAT message 400.

Next, and when, in Step 1225, the ‘timestamp’ of the data item 305-1 of the MCAT message 400 is not more recent than the ‘timestamp’ of the data item 305-n of the same ‘type’ existing in the local media database 225-1 of the first node 200-1, or when at Step 1230 the ‘size’ of the data item 305-1 is such that, the data item 305-1 cannot be accommodated in the local media database 225-1 of the first node 200-1, the operation proceeds to Step 1240. In Step 1240, the first node 200-1 checks if the broadcasted MCAT message 400 contains further items 305-n. When there are no further items, the operation returns to Step 1205 in which the first node 200-1 waits to process further received broadcasted MCAT messages 400.

When the MCAT message 400 contains more items 305-n in Step 1240, the operation continues to Step 1245 in which the first node 200-1 begins to process a next highest ranking item in the MCAT message 400. Next, the operation returns to Step 1215 as discussed previously herein.

Returning to the operation of Step 1215, when the size of the item is not greater than zero, the operation moves to Step 1250, in which the first node 200-1 checks whether a data item 305-n having the same ‘type’ exists in the local media database 225-1 of the first node 200-1 with a same or older ‘timestamp’. When a data item 305-n having the same ‘type’ exists in the local media database 225-1 of the first node 200-1 with a same or older timestamp, the operation continues to Step 1255, in which the first node 200-1 deletes the data item 305-n having the same ‘type’ from the local media database 225-1 of the first node 200-1, reserves the deletion for a predetermined time, and subsequently stores a deletion index containing the deleted data item 305-n with a size equal to 0.

Next, after Step 1255, and when, in Step 1250, the ‘type’ of the data item 305-n does not exist in the local media database 225-1 of the first node 200-1, the operation continues to Step 1240 and the first node 200-1 checks for further data items 305-n in the MCAT message 400 that are waiting to get processed.

The deletion procedure as shown at Steps 1215, 1250 and 1255 ensures that the nodes 200 deletes the data item 305 after the data item 305 has reached a destination node in the network 100. Further, the destination node which receives the data item 305 (i.e. via the MPULL message 800 or the MPUSH message 600) specifically destined for itself will erase the item from the media database 225, (after the data item 305 has been passed to the application or another higher layer entity). However, the destination node retains the index list 310 of the data items 305, and stores the index list 310 of the data item 305 with ‘size’ equal to zero (i.e. the data item 305 itself is purged from the memory 220). Optionally, the node 200 receiving the index list 310 with a ‘size’ strictly greater than zero (via broadcast of MCAT message 400 or MREQ message 500), while possessing the data item 305 in the local media database 225 with same ‘type’ and ‘timestamp’ will send a directed MCAT message 400 with the deletion instruction (that is, containing an index list 310 with the same ‘type’ and ‘timestamp’, and a ‘size’ of zero). Since the deletion requests for data item 305 are sent with ‘size’ equal to zero, the deletion requests have a higher ranking value than the other requests, thereby ensuring that deletion requests are processed prior to other requests. Optionally, some memory space may be reserved for such deletion requests in each of the nodes 200 in the network 100.

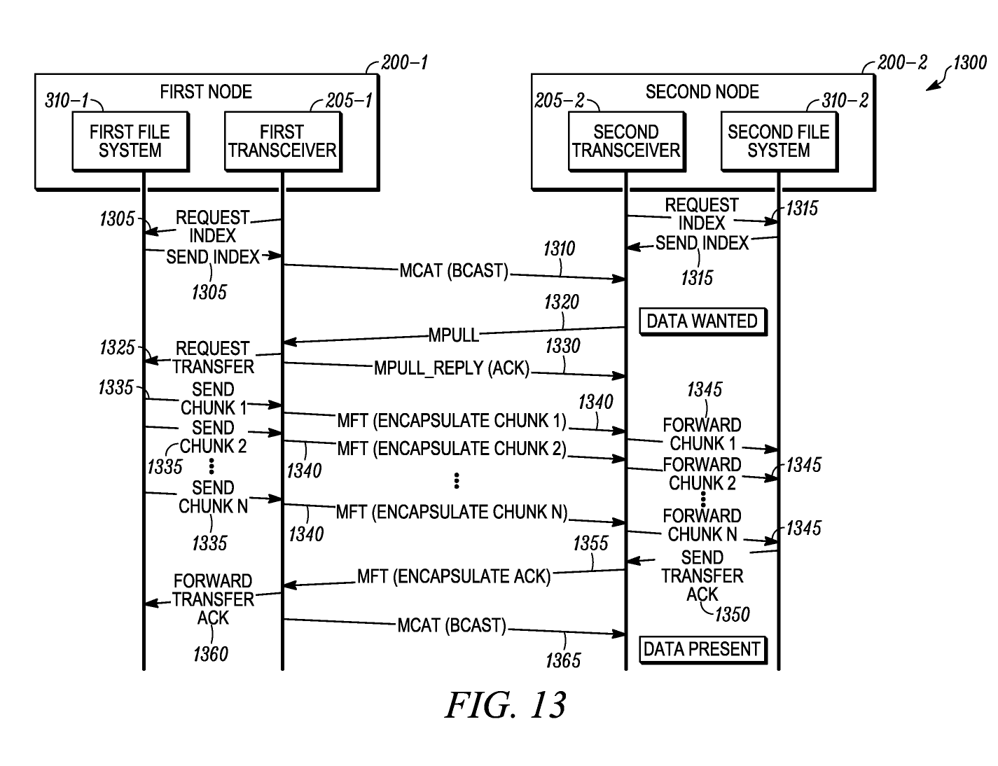

FIG. 13 is an exemplary message flow diagram illustrating a single-hop PULL procedure 1300 in accordance with at least some embodiments of the present invention. Consider a first node 200-1 having a first file system 310-1 and a first transceiver 205-1, and a second node 200-2 having a second file system 310-2 and a second transceiver 205-2. The first file system 310-1 includes data item information 315-n of the data items 305-n stored in the first node 200-1. The second file system 310-2 includes data item information 315-n of the data items 305-n stored in the second node 200-2.

At predetermined intervals, the first transceiver 205-1 of the first node 200-1 retrieves 1305 the data item information 315-n (index) from the first file system 310-1 of the first node 200-1 by requesting and receiving the indices 310, and generates an MCAT message 400 based on the information stored in the first file system 310-1. The first transceiver 205-1 then broadcasts 1310 the MCAT message 400 to the second node 200-2 in the network 100. The second transceiver 205-2 of the second node 200-2 receives the MCAT message 400, retrieves 1315 the data item information 315-n (index) from the second file system 310-2 by requesting and receiving the indices 315-n and compares the indices 310 contained in the MCAT message 400 with the data item information 315-n of the second file system 310-2. If the second node 200-2 decides to accept the data item 305-1 from the first node 200-1, then the second node 200-2 sends 1320 a MPULL message 800 to the first node 200-1. The first transceiver 205-1 of the first node 200-1 receives the MPULL message 800, requests 1325 the first file system 310-1 to transfer the selected data item 305-1, and then transmits 1330 a MPULL_REPLY message 900 with ACK to the second node 200-2. After transmitting the MPULL_REPLY message 900, the first transceiver 205-1 of the first node 200-1 initiates 1335 the file transfer of the selected data item 305-1 by transmitting 1340 the MFT message 1000 to the second node 200-2, wherein the MFT message 1000 includes the encapsulated chunks of data item 305-1. As can be appreciated by a person skilled in the art, the chunks of data item 305-1 described herein refers to sequence of portions or subsets of data grouped together to form the data item 305-1. The second transceiver 205-2 receives the chunks of data items 305-1 and forwards 1345 the chunks to the second file system 310-2 of the second node 200-2. The second file system 310-2 sends 1350 a transfer ACK to the second transceiver 205-2 after the entire data item 305-1 has been stored. The second transceiver 205-2 then sends 1355 a MFT message 1000 including an encapsulated ACK to the first node 200-1 indicating that the second node 200-2 has received the entire data item 305-1. The first transceiver 205-1 forwards 1360 the received MFT message 1000 to the first file system 310-1. After a predetermined interval of time, the first transceiver 205-1 broadcasts 1365 another MCAT message 400. The second node 200-2 receiving the MCAT message 400 no longer needs the data item 305-1, since it has already been transferred.

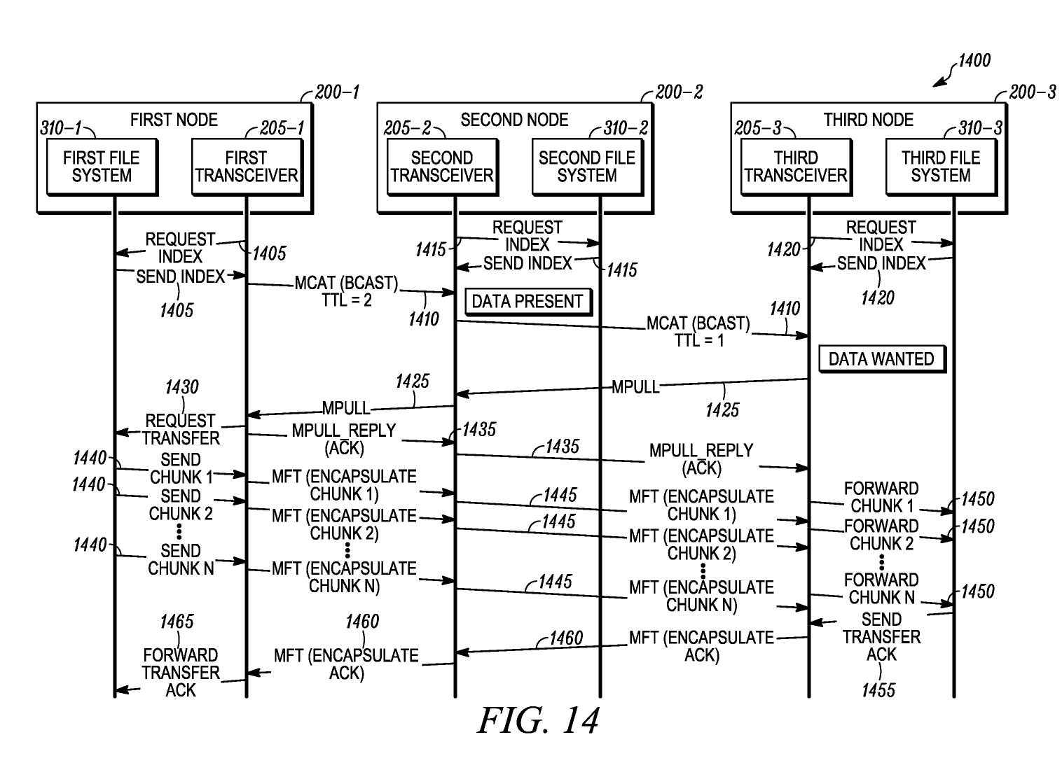

Now referring to FIG. 14, a message flow diagram of multi-hop pull procedure 1400 is illustrated. Consider a first node 200-1 having a first file system 310-1 and a first transceiver 205-1, a second node 200-2 having a second file system 310-2 and a second transceiver 205-2, and a third node 200-3 having a third file system 310-3 and a third transceiver 205-3. The first file system 310-1 includes data item information 315-n of the data items 305-n stored in the first node 200-1. The second file system 310-2 includes data item information 315-n of the data items 305-n stored in the second node 200-2. The third file system 310-3 includes data item information 315-n of the data items 305-n stored in the third node 200-3.

At predetermined intervals, the first transceiver 205-1 retrieves 1405 the data item information 315-n (index) from the first file system 310-1 of the first node 200-1 and generates a MCAT message 400 based on the information stored in the first file system 310-1. The first transceiver 205-1 then broadcasts 1410 the MCAT message 400 with Time to Live (TTL) equal to 2 (or more). The second transceiver 205-2 of the second node 200-2 receives the MCAT message 400, retrieves 1415 the data item information (index) 315-n from the second file system 310-2 and compares the data item information 315-n contained in the MCAT message 400 with the data item information 315-n of the second file system 310-2. As shown in FIG. 14, the second node 200-2 decides not to accept the data items 315-n since the data items 325-n with a more recent ‘timestamp’ are already present in the second file system 310-2 of the second node 200-2. Alternatively, node 200-2 may have items 305-n of higher rank and be out of memory.

The third transceiver 108-3 of the third node 200-3 may also receive the broadcasted MCAT message 400, and as illustrated in FIG. 14, the third node 200-3 retrieves 1420 the data item information 315-n (index) and decides to accept the data item 305-1 from the first node 200-1, and subsequently sends 1425 a MPULL message 800 to the first node 200-1 via the second node 200-2. The first transceiver 205-1 of the first node 200-1 receives the MPULL message 800, requests 1430 the first file system 310-1 to transfer the selected data item 305-1, and then transmits 1435 a MPULL_REPLY message 900 with ACK to the third node 200-3 via the second node 200-2. After transmitting the MPULL_REPLY message 900, the first transceiver 205-1 of the first node 200-1 initiates 1440 the file transfer of the selected data item 305-1 by transmitting 1445 the MFT message 1000 to the third node 200-3 via the second node 200-2, wherein the MFT message 1000 includes the encapsulated chunk of data items 305-1. The third transceiver 205-3 forwards 1450 the chunks to the third file system 310-2. In response to this, the third file system sends 1455 a transfer ACK to the third transceiver 205-3. The third transceiver 205-3 of the third node 200-3 1460 sends MFT message 1000 including an encapsulated ACK to the first transceiver 205-1 of the first node 200-1 via second node 200-2 indicating that the third node 200-3 has received the entire data item 305-1. The first transceiver 205-1 then forwards 1465 the transfer ACK to the first file system 310-1

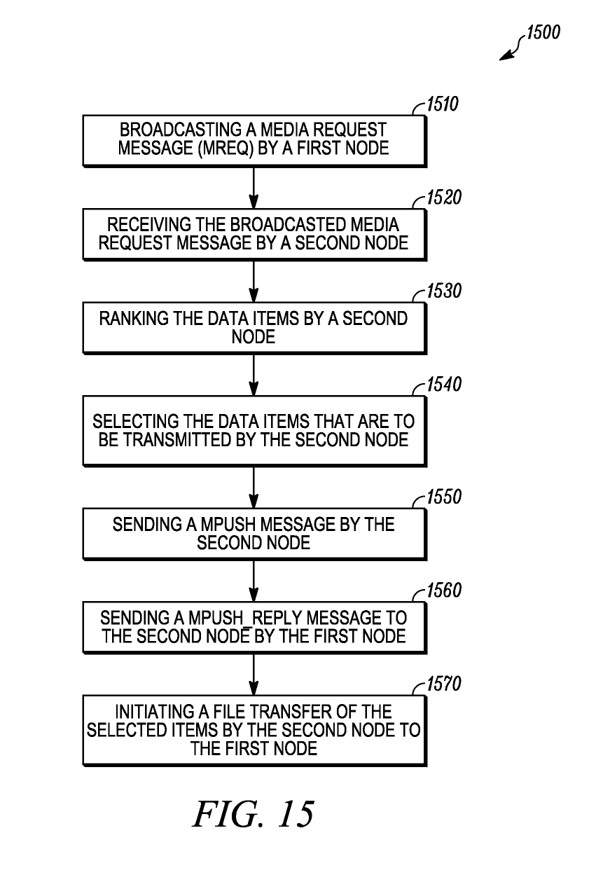

FIG. 15 is an exemplary flowchart of a PULL procedure 1500 in accordance with at least some embodiments of the present invention. In Step 1510, a first node 200-1, when needed, broadcasts a MREQ message 500 including data item information list 310 having data item information 315 associated with one or more data items 305 needed by the first node 200-1. Next, in Step 1520, the broadcasted MREQ message 500 is received by at least one other node 200-2 through 200-n. For example, the broadcasted MREQ message 500 is received by a second node 200-2 in the network 100. Optionally, as shown in Step 1530, a second node 200-2 receiving the broadcasted MREQ message 500 ranks the data items 305 based on the data item information 315 stored in the MREQ message 500. After the data items 305 are ranked, at Step 1540, the second node 200-2 compares each of the data item information 315 associated with each of the data items 305 with a local data index information list 310 to select data items 305 that can be transmitted to the first node 200-1 based on the presence of the data items 305 in the media database 225-2 of the second node 200-2. Next, in Step 1550, the second node 200-2 sends a MPUSH message 600 to the first node 200-1, the MPUSH message 600 containing data item information 315 related to the selected items that are to be transmitted by the second node 200-2 to the first node 200-1. Next, in Step 1560, the first node 200-1, after receiving the MPUSH message 600, sends a MPUSH_REPLY 700 to the second node 200-2 with either an ACK or a NACK. Next, in Step 1570, the second node 200-2, after receiving the MPUSH_REPLY 700, initiates a file transfer of the selected items via a MFT message 1000 if the second node 200-2 receives MPUSH_REPLY 700 with an ACK from the first node 200-1.

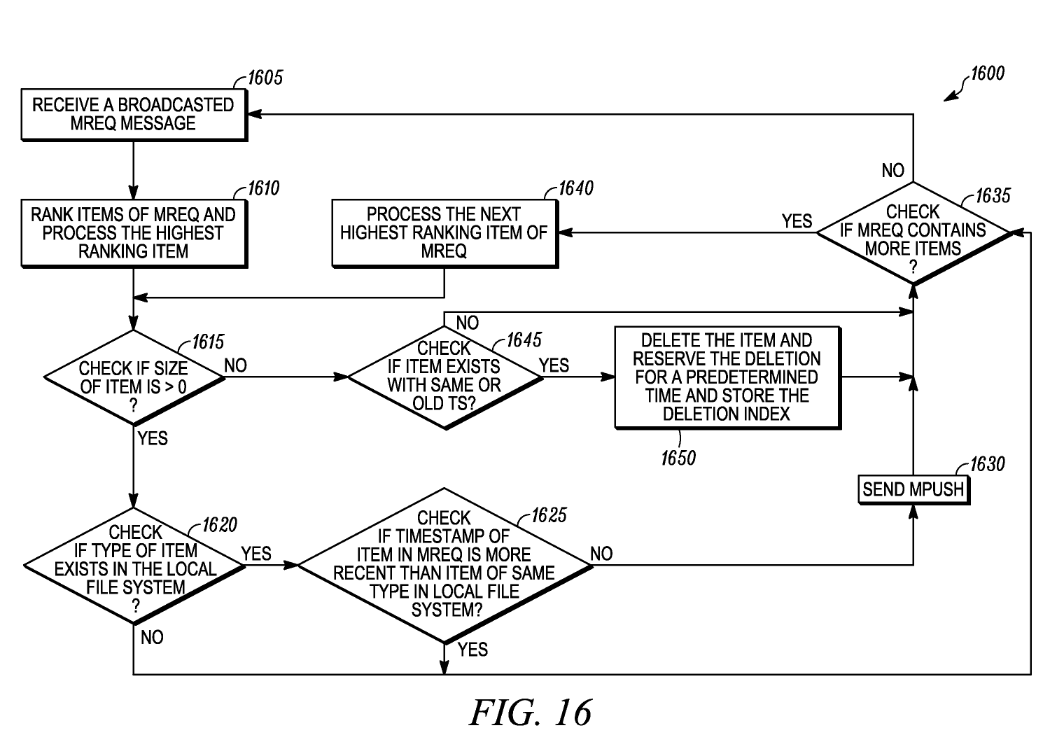

FIG. 16 is an exemplary flowchart of a PUSH procedure 1600, according to at least some embodiments of the present invention. In Step 1605, a first node 200-1 receives a broadcasted MREQ message 500 including data item information list 310 having data item information 315 associated with one or more of data items 305 required by one of the other nodes 200-2 through 200-n, for example, a second node 200-2 in the network 100. Next, in Step 1610, after receiving the broadcasted MREQ message 500, the first node 200-1 optionally ranks items of MREQ message 500 based on the information contained in the MREQ message 500. The rank of the items, for example, may be calculated based on information such as priority, lifetime, and size included in the MREQ message. The first node 200-1 further reorders the ranked items in a decreasing order, and begins to process the highest ranked item. Next, in Step 1615, the first node 200-1 checks whether the ‘size’ of the highest ranked item is greater than zero. When it is determined that the ‘size’ of the highest ranked item is greater than zero, the operation moves to Step 1620, in which the first node 200-1 checks whether the ‘type’ of the item already exists in the local media database 225-1 of the first node 200-1. When the ‘type’ of the item already exists in the local media database 225-1, the operation continues to Step 1625, in which the first node 200-1 determines whether the ‘timestamp’ of the item is more recent than the ‘timestamp’ of the item existing in the local media database 225-1 of the first node 200-1. When the ‘timestamp’ of the item of MREQ message 500 is less recent than the data item 305 existing in the media database 225-1 in Step 1625; then the operation continues to Step 1630, in which the first node 200-1 sends a MPUSH message 600 to the second node 200-2 that had previously broadcasted the MREQ message 500. The transmission of MPUSH message 600 indicates that the first node 200-1 has decided to transmit the data item 305 to the second node 200-2 that has broadcasted MREQ message 500. Next, or when, in Step 1620, the ‘type’ of the item does not exist in the local media database 225-1, or when, in Step 1625, the ‘timestamp’ of the item of MCAT message 400 is not less recent than the ‘timestamp’ of the item of the same ‘type’ existing in the local media database 225-1 of the first node 200-1, the operations proceeds to Step 1635. At Step 1635, the first node 200-1 checks whether the broadcasted MREQ message 500 contains further items. When there are no further items, the operation returns to Step 1605 in which the first node 200-1 waits to process further received broadcasted MREQ messages.

When, in Step 1635, the MREQ contains further items, the operations continues with Step 1640, in which the first node 200-1 begins to process the next highest ranking item in the MREQ message 500. The operation then returns to Step 1615 as discussed previously herein.

Returning to Step 1615, when the ‘size’ of the item is not greater than zero, the operation continues to Step 1645 in which the first node 200-1 checks whether a data item 305 having the same ‘type’ exists in the local media database 225-1 of the first node 200-1 with the same or an older timestamp. When a data item 305 having the same ‘type’ exists in the local media database 225-1 of the first node 200-1 with the same or an older timestamp, the operation continues with Step 1650, in which the first node 200-1 deletes the data item 305 having the same ‘type’ from the local media database 225-1, and reserves the deletion for a predetermined time, and subsequently stores a deletion index containing the deleted data item 305-1 with a size equal to 0. Next, and when a data item 305 having the same ‘type’ does not exist in the local media database 225-1 of the first node 200-1 with the same or an older timestamp in Step 1645, the operation proceeds to Step 1635 as discussed previously herein.

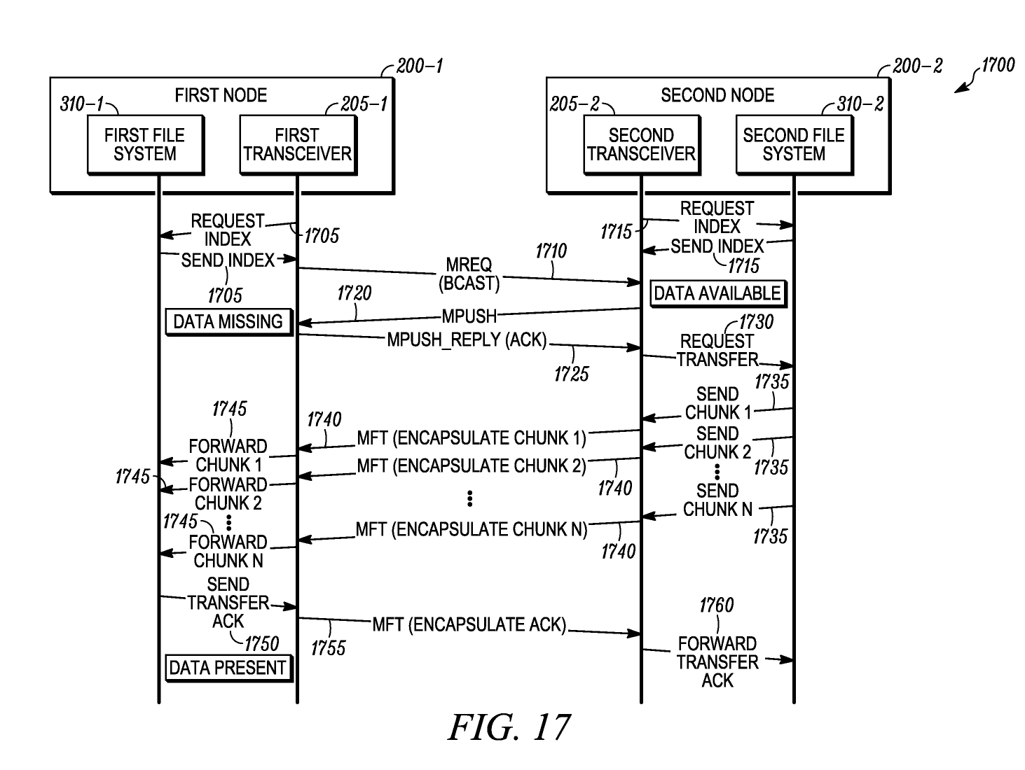

FIG. 17 is a message flow diagram illustrating a PUSH procedure 1700. As can be appreciated by a person skilled in the art, the term ‘unicast’ refers to sending of data items 305 to a single destination. Consider a first node 200-1 having a first file system 310-1 and a first transceiver 205-1, and a second node 200-2 having a second file system 310-2 and a second transceiver 205-2. The first file system 310-1 includes data item information 315-n of the data items 305-n stored in the first node 200-1. The second file system 310-2 includes data item information 315-n of the data items 305-n stored in the second node 200-2.

Whenever the first node 200-1 requires any data items 305, the first node 200-1 retrieves 1705 the data item information 315-n (index) from the first file system 310-1 and generates MREQ message 500 storing data item information 315 related to the required data items 305, and broadcasts 1710 the MREQ message 500 to the second node 200-2 in the network 100. The second transceiver 205-2 of the second node 200-2 receives the MREQ message 500, retrieves 1715 the data item information 315-n (index) from the second file system 310-2 and compares the data item information 315-n of the MREQ message 500 with the data item information 315-n of the second file system 310-2 of the second node 200-2. If the item of the MREQ message 500 is present in the index list 310 of the second file system 310-2, then the second node 200-2 sends 1720 a MPUSH message 600 to the first node 200-1. The first transceiver 205-1 of the first node 200-1 receives the MPUSH message 600, and then transmits 1725 a MPUSH_REPLY message 700 with ACK to the second node 200-2. In response to the MPUSH_REPLY message 700, the second transceiver 205-2 sends 1730 a request transfer to the second file system 310-2 and initiates 1735 the file transfer of the data item 305 by transmitting 1740 the MFT message 1000 to the first node 200-1, wherein the MFT message 1000 includes the encapsulated chunk of data items 305. The first transceiver 205-1 receives the chunks of data items 305 and forwards 1745 the chunks to the first file system 310-1. The first file system 310-1 sends 1750 a transfer ACK to the first transceiver 205-1 after the entire data item 305 has been received. The first transceiver 205-1 then sends 1755 a MFT message including an encapsulated ACK to the second node 200-2 indicating that the second node 200-2 has received the entire data item 305. The second transceiver 205-2 then forwards 1760 the received MFT message 1000 with ACK to the second file system 310-2.

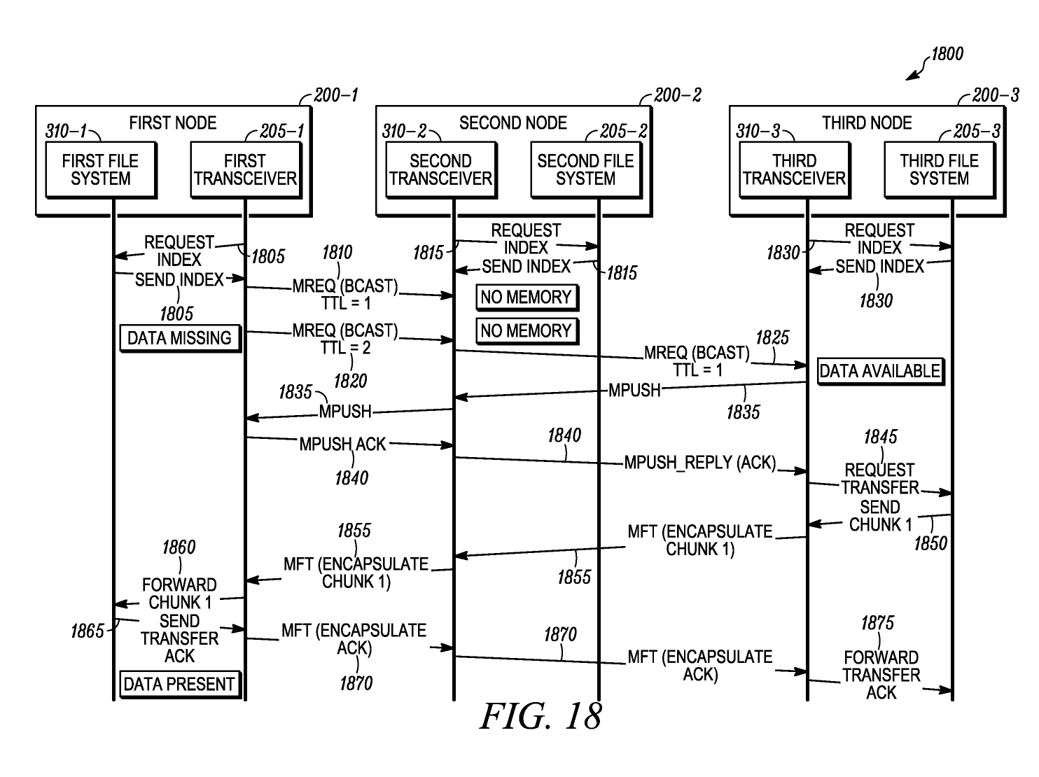

Now referring to FIG. 18, a message flow diagram of a multi-hop push procedure 1800 is illustrated. Consider a first node 200-1 having a first file system 310-1 and a first transceiver 205-1, a second node 200-2 having a second file system 310-2 and a second transceiver 205-2, and a third node 200-3 having a third file system 310-3 and a third transceiver 205-3. The first file system 310-1 includes data item information 315-n of the data items 305-n stored in the first node 200-1. The second file system 310-2 includes data item information 315-n of the data items 315-n stored in the second node 200-2. The third file system 310-3 includes data item information 315-n of the data items 305-n stored in the third node 200-3.

Whenever the first node 200-1 requires any data items 305, the first node 200-1 retrieves 1805 the data item information 315-n (index) by requesting and receiving the indices 310 and generates MREQ message 500 storing information related to the needed data items 305. As shown in FIG. 18, the first transceiver 205-1 initially broadcasts 1810 the generated MREQ message 500 with TTL equal to 1. The second transceiver 205-2 of the second node 200-2 receives the MCAT message 400, retrieves 1815 the data item information 315-n (index from the file system 310-2 and compares the data item information 315-n contained in the MCAT message 400 with the data item information 315-n of the file system 310-2. As shown in FIG. 18, the data item 305 required by the first node 200-1 is not present in the second file system 310-2 of the second node 200-2.

The first transceiver 205-1 of the first node 200-1 periodically broadcasts 1820 an MREQ message 500 with a TTL equal to 2 (or more). Upon receiving the MREQ message 500, the second node 200-2 forwards 1825 the MREQ message 500 to the third transceiver 205-3 of the third node 200-3. The third node 200-3 retrieves 1830 the index list 310 of the file system 310-3 and compares the data item information 315 of the MREQ message 500 with the index list information of the file system 310-3. If the data item 305 is present in the index list 310 of the file system 310-3, then the third node 200-3 sends 1835 a MPUSH message 600 to the first node 200-1 via the second node 200-2. The first transceiver 205-1 of the first node 200-1 receives the MPUSH message 600, and transmits 1840 MPUSH_REPLY message 700 with ACK to the third node 200-3 via the second node 200-2. Upon receiving the MPUSH_REPLY message 700 with ACK, the third transceiver 205-3 sends 1845 a request transfer to the third file system 310-3 and initiates 1850 the file transfer of the data item 305 present in the third file system 310-3 by transmitting 1855 the MFT message 1000 to the first node 200-1 via the second node 200-2, wherein the MFT message 1000 includes the encapsulated chunk of data items 305. The first transceiver 205-3 forwards 1860 the chunks of data item 305 to the first file system 310-1. In response to this, the first file system 310-1 sends 1865 a transfer ACK to the first transceiver 205-1. Next, the first transceiver 200-1 sends 1870 MFT message 1000 including an encapsulated ACK to the third node 200-3 via second node 200-2 indicating that the first node 200-1 has received the entire data item 305. The third transceiver 108-3 receives the MFT message 1000 with ACK, and forwards 1875 the transfer ACK to the third file system 310-3.

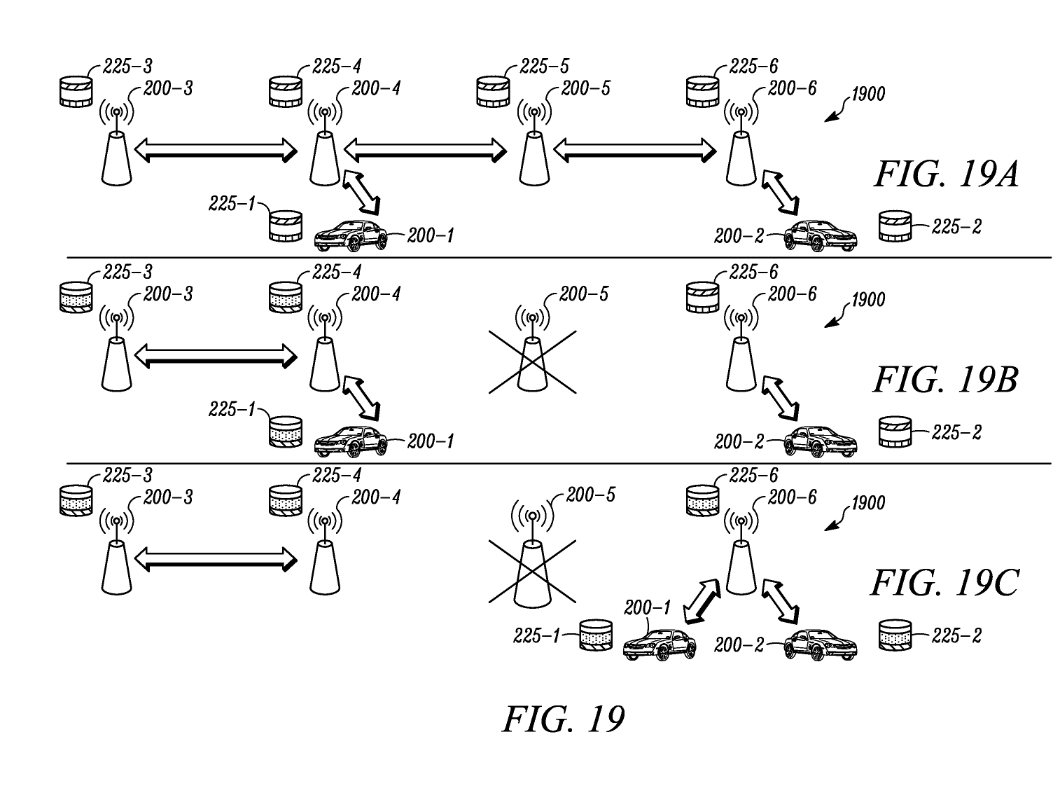

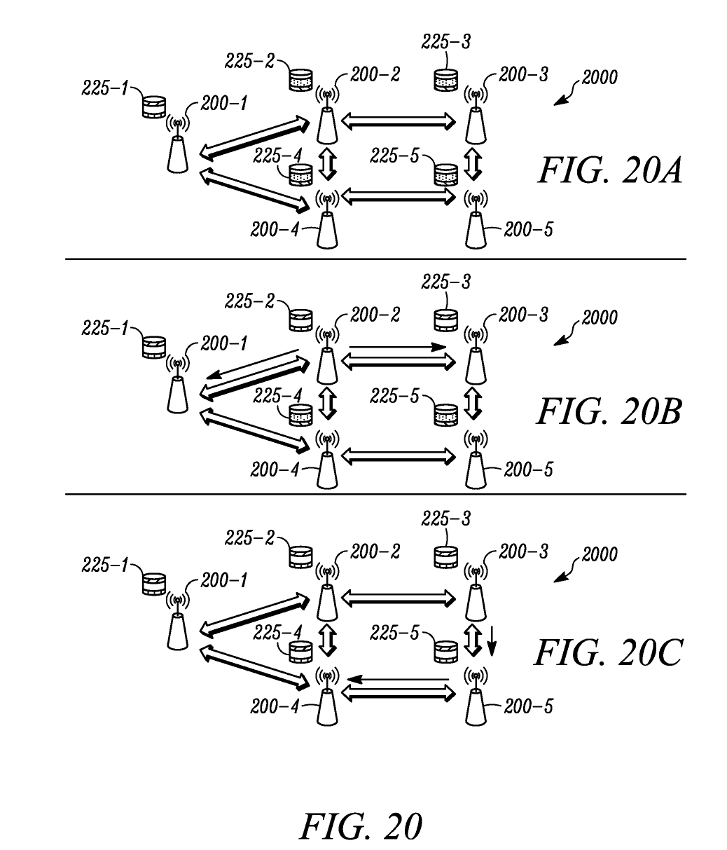

FIGS. 19 through 20 illustrates exemplary applications of the present invention. Referring to FIGS. 19A, 19B, and 19C, a broadcast alert in the network 100, for example, an Intelligent Transportation System (ITS) network 1900 is shown. The ITS network 1900 implemented according to at least some embodiments of the present invention broadcasts an alert whenever there is a traffic congestion in an area of the network 1900. As shown in FIG. 19A, the network 1900 comprises a plurality of nodes 200, for example, mobile nodes 200-1 through 200-2, and a plurality of routers 200-3 through 200-6. Each of the nodes 200 is designed to route the broadcasted alert to the other nodes in the network 1900. For example, the node 200-1 may broadcast an alert to all the other nodes 200-2 through 200-6 in the network 1900. FIG. 19B illustrates a typical example, wherein one of the nodes 200, for example node 200-5, has operationally failed, resulting in a disjoined ITS network 1900. Since the node 200-5 has operationally failed, the nodes 202-6 and 202-2 may be disconnected from the network 1900, and may not have received the broadcasted alert. However, the mobile node 200-1 having the alert data may at predetermined intervals broadcast a MCAT message including information about the alert data. As can be inferred from FIG. 19C, the node 200-5 and node 200-2 may have received the broadcasted MCAT message containing alert data from the mobile node 200-1, and pulled the alert data as described in FIG. 11 and FIG. 12, thereby ensuring that all the nodes 200 in the network 1900 receive the alert data.

FIGS. 20A, 20B, and 20C illustrate a software update in a heavily utilized public access network 2000. The public access network 2000 implemented according to an embodiment of the present invention communicates software update data in a delay-tolerant broadcast fashion even when the network 200 is heavily utilized. A fully utilized public access network 200 comprising a plurality of nodes 200, for example, routers 200-1 through 200-5 shown in FIG. 20A. FIGS. 20B and 20C illustrate a partially utilized public access network 2000, wherein the portion of the network 2000 having less traffic is used to propagate the data. In FIG. 20A, all links are heavily utilized, and no additional data can be propagated. In FIG. 20B, links between 200-1, 200-2 and 200-3 are sufficiently under-utilized that a media transfer can take place. In FIG. 20C, links between 200-3, 200-4 and 200-5 are sufficiently under-utilized that a media transfer can take place. When an operator instructs the network 2000 to perform a software update, the nodes 200 may automatically request update data from their neighbors. The neighbors in possession of the update data may propagate it via unicast (push mechanism) to those who request it. Alternatively, the operator may not have to instruct the network 2000 of an upgrade. In such cases, the node 200 in possession of update data may broadcast MCAT message including information related to the update to other nodes. The other nodes may request the update data via unicast pull mechanism as described in FIG. 13.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of communicating data items across one or more networks, comprising:
receiving a message including a data item information list having data item information associated with each of one or more data items stored in a node of the network;
ranking each of the data items based on each of the associated data item information;
comparing each of the associated data item information of the ranked data items with a local data index information list to select one or more data items requiring updating; and
sending a request for updating the selected data items.

2. The method of claim 1, wherein the data item information comprises one or more of a number of items, a type, a source, a timestamp, a lifetime, a priority, and a size.

3. The method of claim 1, wherein comparing the data item information of the ranked data items comprises comparing a rank of the data item to be updated from the message with the rank of the data item information in the local data index information list.

4. The method of claim 1, wherein comparing the data item information of the ranked data items comprises verifying that there is enough space in memory for updating the data item.

5. The method of claim 1, wherein comparing the data item information of the ranked data item comprises verifying that the local data index information list includes a locally stored data item of a same type with an older time stamp.

6. The method of claim 1, wherein comparing the data item information of the ranked data item comprises checking whether the size of the data item is greater than zero, and deleting locally stored data items when the size of the data item is zero and when the locally stored data item of same type exists with a same or older timestamp.

7. The method of claim 1, further comprising deleting the data items after the data items have reached a destination node in the network.

8. The method of claim 1, wherein the message is one of a media catalogue message or a media request message, transmitted over one or more hops.

9. The method of claim 1, wherein the request for updating the selected data items is one of a media pull message or a media push message, transmitted over one or more hops.

10. The method of claim 1, wherein said request for updating is one of a request for deletion or a deletion of said data items requiring updating.

11. A method of communicating data items across one or more networks, comprising:
receiving a message including a data item information list having data item information associated with one or more data items required by a node in the disjoined network;
comparing each of the data item information associated with each of the data items with a local data index information list to select data items that can be transmitted to the node; and
sending a request for transmitting the selected data items to the node.

12. The method of claim 11, wherein the data item information comprises one or more of a number of items, a type, a source, a timestamp, a lifetime, and a priority.

13. The method of claim 11, wherein comparing the data item information of the data items with the local index information list comprises verifying that the local data index information list includes the data item with a more recent timestamp.

14. The method of claim 11, wherein comparing the data item information of the data items comprises checking whether the size of the data items is greater than zero, and deleting locally stored data items when the size of the data items is zero and when the locally stored data item of same type exists with a same or older timestamp.

15. The method of claim 11, wherein the message is a media request message.

16. The method of claim 11, wherein the request for transmitting the data items is included in a media push message.

17. The method of claim 11, further comprising initiating a file transfer of the data items after sending the request for transmitting the data items.
